(19) United States
(12) Patent Application Publication
(10) Pub. No.: US 2005/0164565 A1
(43) Pub. Date: Jul. 28, 2005

(54) Plastic electrical boxes with sealed external bond wire terminal

(76) Inventor: Mark Fricchione, Middle Island, NY (US)

Correspondence Address: ALFRED M. WALKER, 225 OLD COUNTRY ROAD, MELVILLE, NY, 11747-2712, US

(21) Appl. No.: 10/764,700

(22) Filed: Jan. 26, 2004

(51) Int. Cl. H01R 11/09

(52) U.S. Cl. 439/797

(57) ABSTRACT

An electrical box includes a sealed terminal pair on the side of an F/S or pull box such that an external bond wire and an internal ground wire can be easily connected. A drip cover is provided, which shields the external connection from acid rain. Materials such as brass, copper, or copper/aluminum alloys that are compatible with copper wires are used in the terminals and their connections. In one embodiment, an integrally molded external drip shield is used. In the second embodiment, the terminals are integrally cast with a joint that accepts the terminal pair as an “insert molded” item seals and attaches the external/internal terminals as part of the PVC injection molding process. In the third embodiment, a kit is provided so that a electrical contractor can attach a properly sealed terminal pair on the side of an F/S or pull box in any desired orientation and then attach by adhesive bonding a provided drip shield.

### FIELD OF THE INVEMTION

The present invention relates to electrical boxes and bonding in wet environments, such as at swimming pools.

### BACKGROUND

Electrical boxes made of polyvinyl chloride (PVC) known as F/S boxes are commonly used to house ground fault interrupted (GFI) switches or other equipment. Also boxes known as pull boxes are used in similar circumstances where an external bond wire must be attached to an internal ground connection. The boxes themselves have gasketed panels designed to be watertight.

These boxes are often used for bonding swimming pool equipment such as swimming pool lighting fixtures and even rebar in concrete pools. The equipment is bonded using a heavy gage bare copper wire that is connected on the external surface of the box and further internally connected to a ground wire that is routed via conduit to the earth ground at the load center. This connection of the external bonding wire to the internal ground is typically handled using ordinary hardware components not designed for electrical connection. A waterproof sealing compound, such as Scotchkote from 3M Company, is used on the external surface of the box to seal the hole which penetrates the box as well as the external bonding wire connection.

Weise et al. in U.S. Pat. No. 5,541,363 does show an external terminal on a wet-environment junction box. This terminal is connected via a clamping member to a bonding wire. There is provision for internal connection to a conduit grounding wire. However, this is not an F/S box or pull box. The bond wire connection in Weise is on the bottom of the junction box.

### OBJECTS OF THE INVENTION

It is therefore an object of this invention to provide properly sealed external bond wire terminals and internal ground wire terminals on the sides of PVC F/S or pull boxes.

It is also an object of this invention to insure long-term connection integrity not subject to cold-flow or creep of PVC material.

It is a further object of this invention to provide drip shields to reduce exposure of external bonding terminal to acid rain.

It is also an object of this invention to provide a kit for contractor installation of terminal pairs to existing F/S or pull boxes of ordinary design.

It is an object of this invention to provide these connection features in a cost-effective and convenient manner.

### SUMMARY OF THE INVENTION

The common way of attaching an external bonding wire to an internal ground wire involves drilling a hole in the side of the PVC box and then using a galvanized machine screw with a galvanized nut on the inside to connect the bond wire and the ground wire together electrically through the screw using pairs of galvanized fender washers on either side of the respective wires. A waterproof sealing “goop” is used externally to seal the machine screw and box penetration and to cover the external fender washers.

Galvanized steel is prone to rapid oxidation and rusting especially in contact with copper wires in an acid rain environment. The waterproofing compound is slowly attacked by ultraviolet exposure as well as acid rain.

Since the connection method is by the pressure of a screw and nut through a plastic wall, any relaxation will compromise the connection.

Constant high pressure on PVC can induce stress cracking and will cause cold-flow and creep of the plastic to reduce the pressure force maintaining the integrity of the connection.

These factors almost guarantee a fairly short life to the electrical integrity of the connection through weathering, rot, and creep. The bond is eventually severed (high resistance or complete loss of connection) which creates a dangerous ground fault situation.

The present invention provides a properly sealed terminal pair on the side of an F/S or pull box such that an external bond wire and an internal ground wire can be easily connected.

The set screw on the external bond wire terminal is oriented so that its axis is perpendicular to the box surface to which it is attached. The internal set screw on the ground terminal faces the opening with the front panel removed; this orientation facilitates its use with an ordinary straight screw driver.

Furthermore, a drip cover is provided, which shields the external connection from acid rain. Materials such as brass, copper, or copper/aluminum alloys that are compatible with copper wires are used in the terminals and their connections.

In the first embodiment, an integrally molded external drip shield is used. Then, a pair of terminals are factory bonded using a closed end blind rivet through a conductive sleeve which relieves the PVC box side wall from high stresses. Elastomeric o-rings seal the rivet head to the inner (grounding) terminal and the sleeve and inner terminal to the PVC inner wall. The conduction path from external bond wire terminal to internal grounding terminal involves two parallel connections. These are the rivet body itself as well as the conductive sleeve.

In the second embodiment, the terminals are integrally cast using the “lost wax” process or are attached through a bar which is press fit between them. In either case, a more complex PVC mold having a joint that accepts the terminal pair as an “insert molded” item seals and attaches the external/internal terminals as part of the PVC injection molding process.

In the third embodiment, a kit is provided so that a electrical contractor can attach a properly sealed terminal pair on the side of an F/S or pull box in any desired orientation and then attach by adhesive bonding a provided drip shield. The connection method between the outer and inner terminals is via a highly conductive screw through a highly conductive sleeve. The sealing method uses an o-ring under the screw head and a molded-in-place elastomeric seal on the back side of the bond wire terminal.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a Perspective view of F/S PVC box with prior-art attachment of external bond wire.

FIG. 2 is a Perspective view of PVC pull box with prior art attachment of external bond wire.

FIG. 3 is a Perspective exploded view of prior art bond and ground wire attachment using machine screw, nut and fender washers.

FIG. 4 is a Side view of the attachment of FIG. 3 (prior art) with fender washers, outer covering compound, and box wall in cross section.

FIG. 5 is a Perspective detail showing drip shield over bond wire connector on side of PVC box as per embodiments of this invention.

FIG. 6 is a Side exploded view of parts involved in first embodiment of this invention (drip shield is not shown for clarity in this view).

FIG. 7 is a Side view cross section of first embodiment of this invention using closed-end blind rivet for factory attachment of terminals.

FIG. 8 is a Perspective view of attached dual terminals as used in second embodiment of this invention.

FIG. 9 is a Side view of terminal pair as used in second embodiment as an insert molded assembly with PVC box wall shown in cross section.

FIG. 10 is a Side exploded view of all parts in contractor attached terminal kit which is the third embodiment of this invention.

FIG. 11 is a Back view of bond wire terminal for third embodiment showing molded-in-place gaskets as well as anti-rotation plate.

FIG. 12 is a Side view of assembled bond wire and ground wire terminals of third embodiment prior to attachment of drip shield.

### DETAILED DESCRIPTION OF THE INVENTION

FIGS. 1-4 show various details of prior art bond wire and ground wire installations.

FIG. 1 shows F/S box 1 with two PVC attachment towers 3, two switches 6, housing 2 front plate 4 and elastomeric gasket 5 sealing plate 4 to housing 2. Bond wire 8 was attached to a site-modified box and Scotchkote compound 7 was used to seal external connection features as well as box penetration hole.

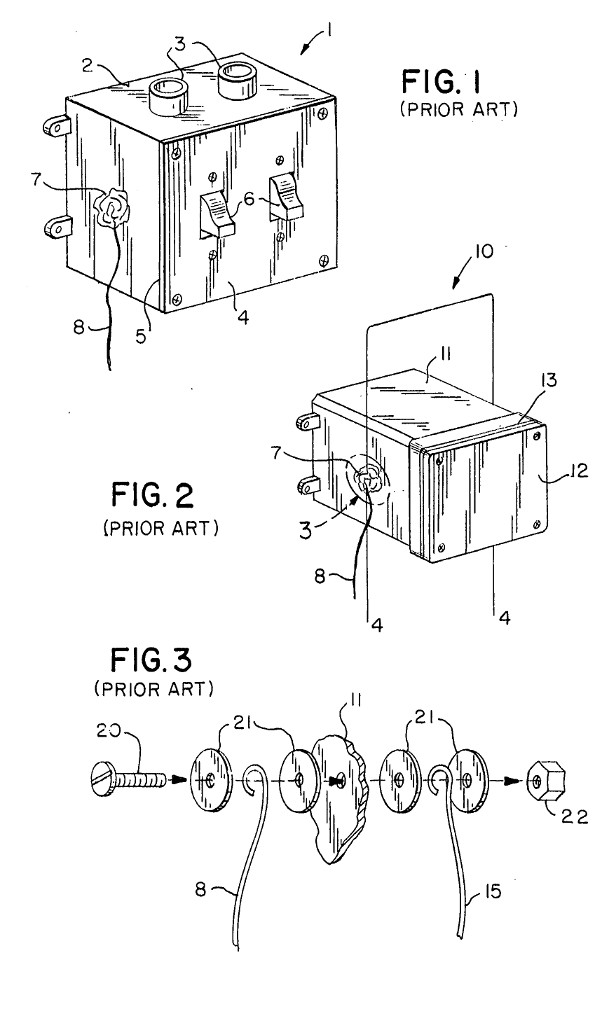

A similar installation is shown in FIG. 2 for PVC pull box 10 with housing 11, front plate 12 and sealing gasket 13. Attachments of conduits to pull box 10 are not shown for clarity in this figure. These F/S and pull boxes are available in a variety of sizes and conduit attachment configurations.

FIG. 3 is an exploded view of the typical prior art site-prepared attachment scheme. All hardware is typically galvanized steel. Machine screw 20 is threaded through fender washers 21 on the exterior with bond wire 8 nestled between, then it further penetrates PVC box wall 11 through a site-drilled hole and further through an inside pair of fender washers 21 capturing ground wire 15 which is part of the conduit bundle. Nut 22 is used to tighten and secure all of the parts.

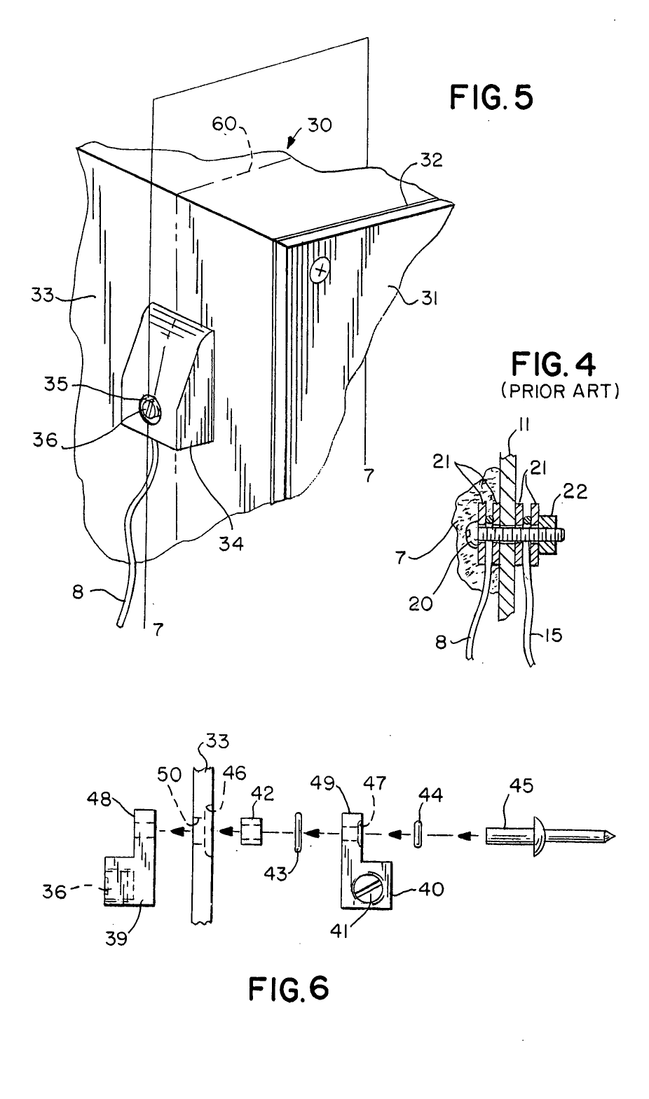

FIG. 4 is a side view of the assembly after tightening with a profile of Scotchkote sealing compound 7. A plurality, such as six, separate components are used to connect the two wires. All of the limitations detailed in the summary should be apparent including the high pressure that PVC wall 11 has to withstand.

FIG. 5 is a detail of an external view of any of the three embodiments of the present invention; their differences are not apparent from this view. PVC box 30 could be either an F/S or a pull box with housing 33, front panel 31, and gasket 32. Drip shield 34 protects the bond wire terminal within from acid rain. Access hole 35 permits set screw 36 to be tightened over bond wire 8.

FIG. 6 is an exploded side view of the terminal parts and method of attachment of the first embodiment. Drip shield 34 is not shown in this view for clarity; it is integrally molded with housing 33.

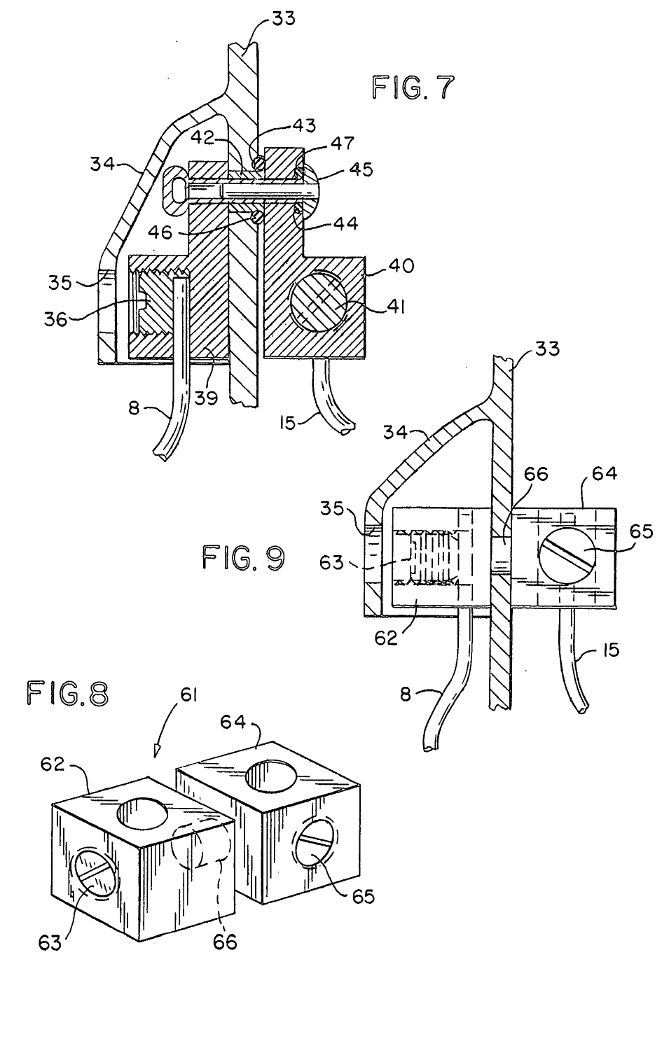

FIG. 7 shows a side cross section as per the plane shown in FIG. 5. Bond wire terminal 39 with attachment extension 48 has a hole which receives closed end blind rivet 45. Metallic sleeve 42 is slightly longer than the thickness of housing wall 33. O-ring 43 has an inside diameter equal to the outside diameter of sleeve 42 and, when compressed, fits in recess 46 which is molded into the inner side of penetration hole 50. Finally, o-ring 44 seals the head of rivet 45 by fitting in hole recess 47 on the inside surface of attachment extension 49 of ground wire terminal 40 (with set screw 41). In this way, the connections between the two terminals are totally sealed and sleeve 42 protects PVC wall 33 from undue crushing pressure. The assembly method is to insert terminal 39 through the bottom opening of drip shield 34 and then engaging all of the other components from inside box 30. The close side fit on the inside of drip shield 34 keeps the entire assembly from rotating when tightening set screw 36 or pressing on set screw 41 on the inside. The dual conduction paths from bond terminal to ground terminal are through sleeve 42 and rivet 45.

The second embodiment shown in FIGS. 8 and 9 makes use of a dual terminal 61 which can be investment cast as a single unit or attached via a separate coupling bar 66 which is press fit under high pressure to attached bond terminal 62 to ground terminal 64.

FIG. 9 shows how this can be dropped in at a mold seam prior to injection molding to be captured and sealed into wall 33 when hot PVC is flowed in. Set screws 63 and 65 tighten onto bond wire 8 and ground wire 15 respectively. It can be appreciated that this second embodiment would look almost identical to the first embodiment externally. There is a slight difference however; a faint mold separation line 60 in FIG. 5 (shown as a dashed line) would be visible on this embodiment only upon close inspection.

It can be appreciated that even the orientation of identical PVC boxes would differentiate the first and second embodiments since drip shield 34 must be molded in the proper orientation. In the third embodiment, a kit is provided that can facilitate the attachment of bond wire and grounding terminals as well as drip shield on-site by the contractor. In this way, plain boxes can be used in a variety of orientations and customized on-site.

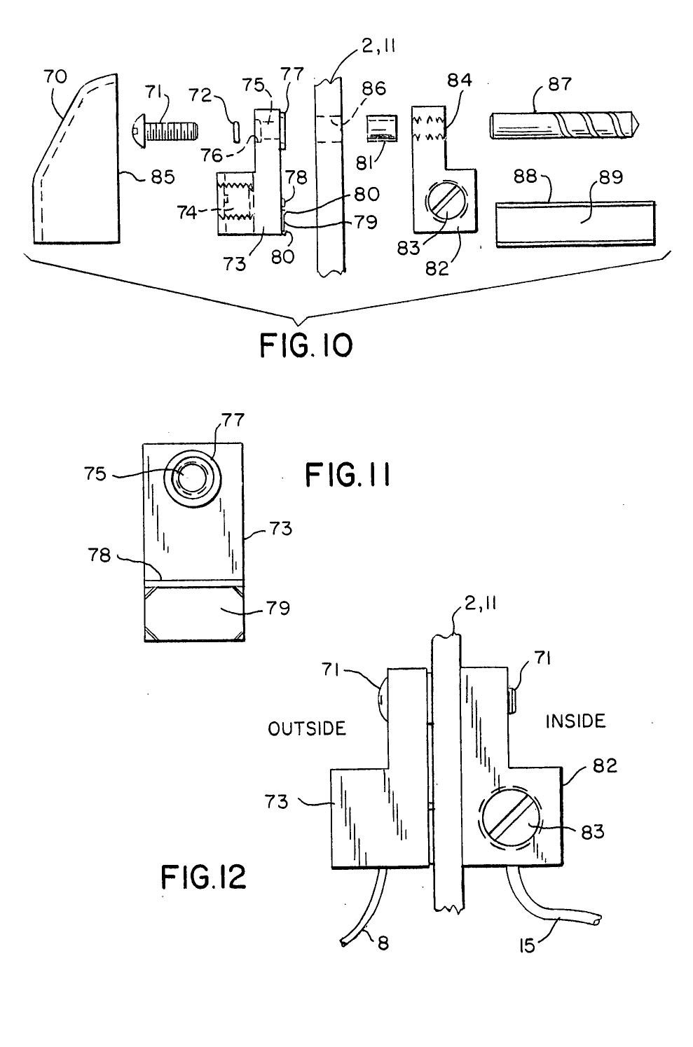

FIG. 10 shows an exploded side view of all of the attached components plus drill bit 87 and tape strip 89 on release liner 88. Drill bit 87 is supplied to be the proper clearance size for sleeve 81 so that a hole in PVC wall 2 or 11 can be made conveniently. Highly conductive screw 71 (copper, brass, AL/CU) is sealed to front recess 76 in bond connector 73 by o-ring 72. Sleeve 81 is slightly longer than wall 2 or 11 thickness.

Since there is more variation in wall thickness than in the factory applied embodiments, the sealing method compensates by using thick soft seals such as molded-in-place elastomeric ring seal 77, such as a silicone ring seal, around hole 75 (see back of connector 73 in FIG. 11) and stripe 78 which is optional support. Alternatively, a die-cut bonded elastomer sheet on the back of connector 73 can be used; closed cell foam can also be used. A sheet metal plate 79 with turned-up corners 80 is adhesively attached as shown in FIGS. 10 and 11. This digs into the surface of wall 2 or 11 after tightening of screw 71 in threaded hole 84 of ground connector 82. This resists rotation of the assembled terminals. This feature or a similar anti-rotation feature (bonded abrasive will also serve well) is required for two reasons. First, the terminals are assembled and connected to wires 8 and 15 by set screws 74 and 83 respectively before drip shield 70 is attached. Secondly, due to the soft seal used on the back of terminal 73, there is less natural rotation resistance. After terminal assembly and wire attachment, PVC cement is spread onto edge 85 of drip shield 70. It is then fitted against wall 2 or 11 in the proper orientation over terminal 73. Tape strip 89 is then used to temporarily hold drip shield 70 until PVC cement cures.

In any of the three embodiments, an anti-oxidation paste such as Noalox from Ideal Industries of Sycamore, Ill. can be used to further resist oxidation of external components by applying to fill the inside of the drip shield.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended claims.

1. Apparatus for electrically connecting first and second conductors through an electrically insulating wall of an electrical box comprising:
a first wire terminal on an outside surface of said wall for receiving said first conductor;
a second wire terminal on an inside surface of said wall directly opposite said first wire terminal for receiving said second conductor;
a metal rod of conductive material passing through a penetration hole in said wall and both said first and second wire terminals for providing electrical connection between said first and second conductors, said metal rod having ends extending out from outer surfaces of said first and second wire terminals;
a metallic sleeve on said metal rod within said penetration hole;
a first o-ring surrounding said metallic sleeve adjacent the inside surface of said wall;
a second o-ring surrounding said metal rod along an outer surface of said second wire terminal; and
means capping the ends of said metal rod compressing said o-rings to insure that said first and second wire terminals are tightly joined through and to said wall in a water tight connection.

2. The apparatus of claim 1 in which a recess is molded into an inner side of said penetration hole to accommodate said first o-ring when compressed.

3. The apparatus of claim 2 in which the outer surface of said second wire terminal is provided with a recess surrounding said metal rod to accommodate said second o-ring when compressed.

4. The apparatus of claim 1 having a drip shield mounted on the outside of said wall covering said first wire terminal.

5. The apparatus of claim 4 having a set screw in said first wire terminal for tightening said first conductor within said first wire terminal, and an opening in said drip shield for providing access to said set screw.

6. The apparatus of claim 1 wherein said metal rod is a closed end blind rivet facilitating rapid factory assembly and proper tensioning for electrical conduction and sealing.

7. The apparatus of claim 1 wherein a set screw on said second wire terminal faces said electrical box cover opening for easy attachment of said second conductor.

8. Apparatus for electrically connecting first and second conductors through an electrically insulating wall of an electrical box in a water tight connection comprising:
a first wire terminal on an outside surface of said wall for receiving said first conductor;
a second wire terminal on an inside surface of said wall directly opposite said first wire terminal for receiving said second conductor;
a metal rod of conductive material passing through a penetration hole in said wall terminating in and integral with both said first and second wire terminals forming a one piece member.

9. The apparatus of claim 8 having a drip shield mounted on the outside surface of said wall covering said first wire terminal.

10. The method of electrically connecting first and second conductors through an electrically insulating wall of an electrical box in a water tight connection comprising the steps of:
joining a conductive rod member at both ends with first and second wire terminals;
molding a wall of an electrical junction box made from electrically insulating material around said rod member to provide a water tight connection through said wall;
terminating a first electrical conductor in said first wire terminal; and
terminating a second electrical conductor in said second wire terminal.

11. The method of claim 10 including the step of using a set screw to bind said first electrical conductor to said first wire terminal.

12. The method of claim 11 including the step of using a set screw to bind said second electrical conductor to said second wire terminal.

13. The method of claim 11 including the step of covering said first wire terminal with a drip shield.

14. The method of claim 13 including the step of providing an opening in said drip shield to provide access to said set screw.

15. A kit for use in electrically connecting first and second conductors through an electrically insulating wall of an electrical box comprising:
a first wire terminal to be mounted on an outside surface of said wall for receiving said first conductor and having a hole passing therethrough, said first wire terminal having a face adapted to abut said outside surface, said face having a molded-in-place elastomeric seal around said hole;
a second wire terminal to be mounted on an inside surface of said wall directly opposite said first wire terminal for receiving said second conductor, said second wire terminal having a hole therethrough to be aligned with the hole through said first wire terminal;
a drill bit for producing a penetration hole in said wall;
a lengthwise extending tape;
a machine screw of conductive material for use in passing through said penetration hole in said wall and said holes in said first and second wire terminals for providing electrical connection between said first and second conductors, said machine screw being of sufficient length to extend out from outer surfaces of said first and second wire terminals;
a metallic sleeve for use on said machine screw within said penetration hole;
threads on said second wire terminal engaging said machine screw for tightening said first and second wire terminals on said wall, compressing said elastomeric ring seal to insure a water tight connection; and
means mounted on said face of said first wire terminal to prevent said first wire terminal from rotating as said machine screw is tightened.

16. The kit of claim 15 having a drip shield for mounting on the outside of said wall for covering said first wire terminal.

17. The kit of claim 16 wherein said drip shield is adhesively bonded to said outer surface of said electrical box while being temporarily held in place by said lengthwise extending tape until said adhesive sets.

18. The kit of claim 16 in which said drip shield has an opening through which a set screw in said first wire terminal may be tightened against said first conductor.
